(19) United States
(12) Patent Application Publication
(10) Pub. No.: US 2026/0261451 A1
(43) Pub. Date: Sep. 3, 2026

(54) IN-VEHICLE RELAY DEVICE, RELAY METHOD, AND RELAY PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Michihiro HETSUGI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/165,457

(22) PCT Filed: Feb. 28, 2024
(86) PCT No.: PCT/JP2024/007361

§ 371 Date: Sep. 15, 2025

(30) Foreign Application Priority Data
Mar. 16, 2023 (JP) 2023-042202

(51) Int. Cl. H04L 12/40

(52) U.S. Cl. CPC H04L 12/40143; H04L 2012/40273

(57) ABSTRACT

An in-vehicle relay device includes: a relay unit configured to perform relay processing for relaying frames transmitted and received between in-vehicle devices; and a monitoring unit configured to acquire a measurement result of a communication load on a bus to which the frames are to be relayed. The relay unit performs selection processing for selecting whether to relay the frames according to priority levels of the frames or to relay the frames according to order of reception of the frames at the in-vehicle relay device, depending on the measurement result acquired by the monitoring unit.

### CROSS-REFERENCE TO RELATED APPLICATIONS

This application is the U.S. national stage of PCT/JP2024/007361 filed on Feb. 28, 2024, which claims priority of Japanese Patent Application No. JP 2023-042202 filed on Mar. 16, 2023, the contents of which are incorporated herein.

### TECHNICAL FIELD

The present disclosure relates to an in-vehicle relay device, a relay method, and a relay program.

### BACKGROUND

JP 2006-287738A discloses the following network system. In a network system including a gateway node with at least one connection destination connected to a CAN bus network, the gateway node includes: a bus load monitoring means for monitoring frames sent to the CAN bus and monitoring the bus load state of the CAN bus; and a bus load adjustment means for adjusting the bus load depending on the bus load state detected by the bus load monitoring means.

In the network system described in JP 2006-287738A, if the bus load is high, processing for reducing relay processing of frames and processing for reducing the data length of frames to be relayed are performed. However, this processing may be inappropriate depending on the content of the frames to be relayed.

The present disclosure has been made to solve the problem stated above, and an object thereof is to provide an in-vehicle relay device, a relay method, and a relay program that can reduce the bus load while suppressing an impact on frame relay processing in an in-vehicle network.

Relay devices that perform relay processing in in-vehicle networks have conventionally been developed.

### SUMMARY

An in-vehicle relay device according to the present disclosure includes: a relay unit configured to perform relay processing for relaying frames transmitted and received between in-vehicle devices; and a monitoring unit configured to acquire a measurement result of a communication load on a bus to which the frames are to be relayed, wherein the relay unit performs selection processing for selecting whether to relay the frames according to priority levels of the frames or to relay the frames according to order of reception of the frames at the in-vehicle relay device, depending on the measurement result acquired by the monitoring unit.

A relay method according to the present disclosure is a relay method in an in-vehicle relay device that relays frames transmitted and received between in-vehicle devices, the relay method including: a step of acquiring a measurement result of a communication load on a bus to which the frames are to be relayed; and a step of performing selection processing for selecting whether to relay the frames according to priority levels of the frames or to relay the frames according to order of reception of the frames at the in-vehicle relay device, depending on the acquired measurement result.

A relay program according to the present disclosure is a relay program to be used in an in-vehicle relay device, the relay program causing a computer to function as: a relay unit configured to perform relay processing for relaying frames transmitted and received between in-vehicle devices; and a monitoring unit configured to acquire a measurement result of a communication load on a bus to which the frames are to be relayed, wherein the relay unit is configured to perform selection processing for selecting whether to relay the frames according to priority levels of the frames or to relay the frames according to order of reception of the frames at the in-vehicle relay device, depending on the measurement result acquired by the monitoring unit.

An aspect of the present disclosure can be implemented not only as an in-vehicle relay device including such characteristic processing units, but also as a semiconductor integrated circuit that implements the whole or part of the in-vehicle relay device or as an in-vehicle communication system that includes the in-vehicle relay device.

### Advantageous Effects

According to the present disclosure, it is possible to reduce the bus load while suppressing the impact on frame relay processing in an in-vehicle network.

### BRIEF DESCRIPTION OF DRAWINGS

FIG. 1 is a diagram showing a configuration of an in-vehicle communication system according to an embodiment of the present disclosure.

FIG. 2 is a diagram showing an example of a CAN frame transmitted by an in-vehicle ECU in the in-vehicle communication system according to the embodiment of the present disclosure.

FIG. 3 is a diagram showing a configuration of an in-vehicle relay device according to the embodiment of the present disclosure.

FIG. 4 is a diagram showing an example of a priority level table in the in-vehicle relay device according to the embodiment of the present disclosure.

FIG. 5 is a diagram for illustrating relay processing and selection processing by the in-vehicle relay device according to the embodiment of the present disclosure.

FIG. 6 is a diagram for illustrating relay processing and selection processing by the in-vehicle relay device according to the embodiment of the present disclosure.

FIG. 7 is a timing chart showing an example of relay processing and selection processing of CAN frames by the in-vehicle relay device according to the embodiment of the present disclosure.

FIG. 8 is a flowchart showing an example of an operation procedure when the in-vehicle relay device according to the embodiment of the present disclosure performs relay processing and selection processing.

### DETAILED DESCRIPTION OF PREFERRED EMBODIMENTS

First, embodiments of the present disclosure will be listed and described. In a first aspect, an in-vehicle relay device according to an embodiment of the present disclosure includes: a relay unit configured to perform relay processing for relaying frames transmitted and received between in-vehicle devices; and a monitoring unit configured to acquire a measurement result of a communication load on a bus to which the frames are to be relayed, wherein the relay unit performs selection processing for selecting whether to relay the frames according to priority levels of the frames or to relay the frames according to order of reception of the frames at the in-vehicle relay device, depending on the measurement result acquired by the monitoring unit.

Thus, with the configuration in which whether to relay the frames according to the priority levels of the frames or to relay the frames according to the order of reception of the frames at the in-vehicle relay device is selected depending on the communication load on the bus to which the frames are to be relayed, appropriate relay processing can be selected depending on the communication status of the bus to which the frames are to be relayed, and the communication load on the bus to which the frames are to be relayed can be reduced without requiring thinning or data reduction of the frames to be relayed. It is therefore possible to reduce the bus load while suppressing the impact on frame relay processing in the in-vehicle network.

In a second aspect according to the first aspect, the relay unit may accumulate the frames received by the in-vehicle relay device and relay the frames that were accumulated, and the monitoring unit may calculate the communication load on the bus to which the frames are to be relayed, based on the frames accumulated by the relay unit.

With this configuration, the frame reception status of the in-vehicle relay device can be promptly ascertained and reflected in the selection processing.

In a third aspect according to the second aspect, the relay unit may be configured to perform the selection processing for accumulated frames that are the frames that were accumulated, depending on the communication load calculated based on the accumulated frames.

With this configuration, the selection processing can more accurately reflect the frame reception status of the in-vehicle relay device. Thus, the adaptability of the selection processing to the communication status can be enhanced.

In a fourth aspect according to any of the first to the third aspects, the monitoring unit may acquire a measurement result of a communication load on each bus, and the relay unit may perform, for each bus, the selection processing for frames to be relayed to the bus depending on the measurement result corresponding to the bus.

With this configuration, the communication load can be calculated for each bus connected to the in-vehicle relay device, and the selection processing can be performed for each bus. As a result, the bus load in the in-vehicle network can be reduced more effectively.

In a fifth aspect according to any of the first to the fourth aspects, the relay unit may perform the relay processing for relaying a periodic frame containing a periodically transmitted message and an event frame containing an event message, and the event frame may be assigned a higher priority level than the periodic frame.

With this configuration, even in a situation where the communication load is high, a more stable in-vehicle communication system can be constructed by, for example, preferentially transmitting an event message with higher urgency.

In a sixth aspect according to any of the first to the fifth aspects, the monitoring unit may classify the frames received by the in-vehicle relay device into groups corresponding to the respective priority levels, and the relay unit may transmit, on a per-group basis, the frames classified by the monitoring unit, in the relay processing for relaying the frames according to the priority levels of the frames.

With this configuration, all frames belonging to a group with a higher priority level can be relayed more reliably.

In a seventh aspect, a relay method according to an embodiment of the present disclosure is a relay method in an in-vehicle relay device that relays frames transmitted and received between in-vehicle devices, the relay method including: a step of acquiring a measurement result of a communication load on a bus to which the frames are to be relayed; and a step of performing selection processing for selecting whether to relay the frames according to priority levels of the frames or to relay the frames according to order of reception of the frames at the in-vehicle relay device, depending on the acquired measurement result.

Thus, with the configuration in which whether to relay the frames according to the priority levels of the frames or to relay the frames according to the order of reception of the frames at the in-vehicle relay device is selected depending on the communication load on the bus to which the frames are to be relayed, appropriate relay processing can be selected depending on the communication status of the bus to which the frames are to be relayed, and the communication load on the bus to which the frames are to be relayed can be reduced without requiring thinning or data reduction of the frames to be relayed. It is therefore possible to reduce the bus load while suppressing the impact on frame relay processing in the in-vehicle network.

In an eighth aspect, a relay program according to an embodiment of the present disclosure is a relay program to be used in an in-vehicle relay device, the relay program causing a computer to function as: a relay unit configured to perform relay processing for relaying frames transmitted and received between in-vehicle devices; and a monitoring unit configured to acquire a measurement result of a communication load on a bus to which the frames are to be relayed, wherein the relay unit performs selection processing for selecting whether to relay the frames according to priority levels of the frames or to relay the frames according to order of reception of the frames at the in-vehicle relay device, depending on the measurement result acquired by the monitoring unit.

Thus, with the configuration in which whether to relay the frames according to the priority levels of the frames or to relay the frames according to the order of reception of the frames at the in-vehicle relay device is selected depending on the communication load on the bus to which the frames are to be relayed, appropriate relay processing can be selected depending on the communication status of the bus to which the frames are to be relayed, and the communication load on the bus to which the frames are to be relayed can be reduced without requiring thinning or data reduction of the frames to be relayed. It is therefore possible to reduce the bus load while suppressing the impact on frame relay processing in the in-vehicle network.

Embodiments of the present disclosure will be described below with reference to the drawings. The same or corresponding parts are given the same reference signs in the drawings and their description will not be repeated. The embodiments described below may be at least partly combined in any way.

### Configuration and Basic Operation

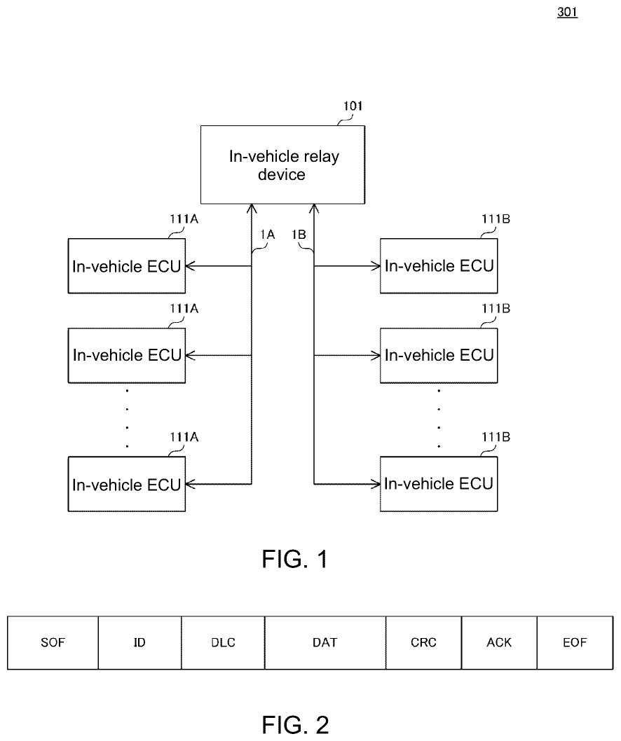

FIG. 1 is a diagram showing a configuration of an in-vehicle communication system according to an embodiment of the present disclosure. With reference to FIG. 1, an in-vehicle communication system 301 includes an in-vehicle relay device 101, a plurality of in-vehicle electronic control units (ECUs) 111A, and a plurality of in-vehicle ECUs 111B. The in-vehicle ECUs 111A and 111B are examples of in-vehicle devices. Hereinafter, each of the in-vehicle ECUs 111A and 111B is also referred to as an in-vehicle ECU 111.

The plurality of in-vehicle ECUs 111A are connected to the in-vehicle relay device 101 via a bus 1A that conforms to the CAN (registered trademark) standard. The plurality of in-vehicle ECUs 111B are connected to the in-vehicle relay device 101 via a bus 1B that conforms to the CAN standard. Hereinafter, each of the buses 1A and 1B is also referred to as a bus 1.

The in-vehicle ECUs 111A and 111B transmit and receive CAN frames, which are frames conforming to the CAN standard.

The in-vehicle relay device 101 may be connected to three or more CAN buses. The in-vehicle communication system 301 may include a plurality of in-vehicle relay devices 101, and the in-vehicle relay devices 101 may be connected via a CAN bus.

FIG. 2 is a diagram showing an example of a CAN frame transmitted by an in-vehicle ECU in the in-vehicle communication system according to the embodiment of the present disclosure. With reference to FIG. 2, the CAN frame includes a Start Of Frame (SOF) field, an ID field, a DLC field, a data field (hereinafter also referred to as a DAT field), a Cyclic Redundancy Check (CRC) field, an ACK field, and an EOF field, in order from the beginning of the frame.

Each in-vehicle ECU 111A periodically or non-periodically generates CAN frames in which data to be transmitted to the other in-vehicle ECUs 111A and the in-vehicle ECUs 111B is stored in the DAT field, and transmits the generated CAN frames to the other in-vehicle ECUs 111A and the in-vehicle relay device 101 via the bus 1A.

Each in-vehicle ECU 111B periodically or non-periodically generates CAN frames in which data to be transmitted to the in-vehicle ECUs 111A and the other in-vehicle ECUs 111B is stored in the DAT field, and transmits the generated CAN frames to the other in-vehicle ECUs 111B and the in-vehicle relay device 101 via the bus 1B.

The in-vehicle relay device 101 is capable of relaying CAN frames received from the in-vehicle ECUs 111A via the bus 1A to the in-vehicle ECUs 111B. The in-vehicle relay device 101 is also capable of relaying CAN frames received from the in-vehicle ECUs 111B via the bus 1B to the in-vehicle ECUs 111A.

### In-vehicle Relay Device

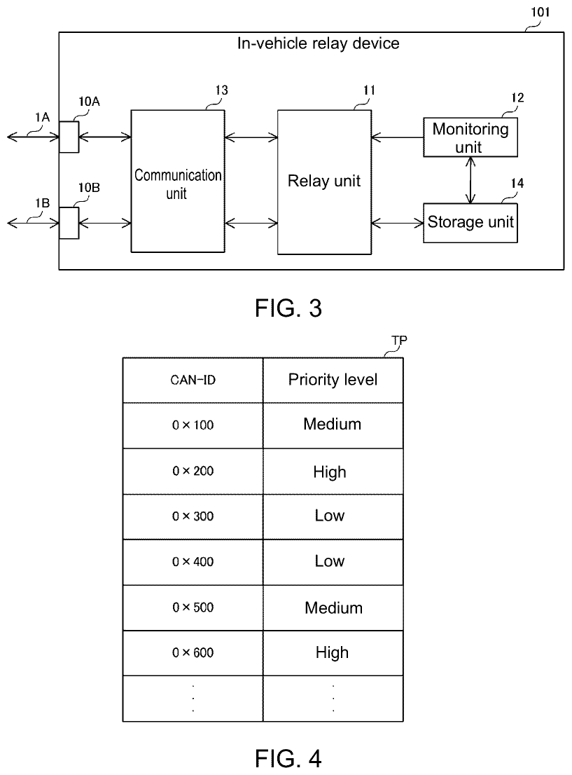

FIG. 3 is a diagram showing the configuration of the in-vehicle relay device according to the embodiment of the present disclosure. With reference to FIG. 3, the in-vehicle relay device 101 includes a plurality of communication ports 10, a relay unit 11, a monitoring unit 12, a communication unit 13, and a storage unit 14. The relay unit 11, the monitoring unit 12, and the communication unit 13 are, for example, partially or entirely implemented by a processing circuit (circuitry) including one or more processors. The storage unit 14 is, for example, a non-volatile memory included in the processing circuit.

As one example, the in-vehicle relay device 101 includes communication ports 10A and 10B as the communication ports 10. The bus 1A is connected to the communication port 10A, and the bus 1B is connected to the communication port 10B.

The communication unit 13 receives CAN frames from the in-vehicle ECUs 111A and 111B. More specifically, the communication unit 13 receives CAN frames from the in-vehicle ECUs 111A via the communication port 10A and outputs the received CAN frames to the relay unit 11. The communication unit 13 also receives CAN frames from the in-vehicle ECUs 111B via the communication port 10B and outputs the received CAN frames to the relay unit 11.

Relay Processing

The relay unit 11 performs relay processing for relaying CAN frames transmitted and received between in-vehicle ECUs 111. More specifically, the relay unit 11 performs relay processing for CAN frames received by the communication unit 13 via the communication port 10A and relay processing for CAN frames received by the communication unit 13 via the communication port 10B.

The storage unit 14 stores, for example, a routing table indicating the correspondence between the ID of each CAN frame (hereinafter also referred to as CAN-ID), the bus 1 to which the in-vehicle ECU 111 that is the transmission source of the CAN frame is connected (hereinafter also referred to as a source bus), and the bus 1 to which the in-vehicle ECU 111 that is the transmission destination of the CAN frame is connected (hereinafter also referred to as a destination bus).

The relay unit 11 refers to the routing table in the storage unit 14 to specify the destination bus corresponding to the CAN-ID and source bus of a CAN frame, and outputs the CAN frame to the identified destination bus via the communication unit 13 and the corresponding communication port 10. Specifically, the relay unit 11 transmits a CAN frame received from an in-vehicle ECU 111A to an in-vehicle ECU 111B via the communication port 10B and the bus 1B. The relay unit 11 also transmits a CAN frame received from an in-vehicle ECU 111B to an in-vehicle ECU 111A via the communication port 10A and the bus 1A.

For example, the relay unit 11 accumulates CAN frames received by the in-vehicle relay device 101, and relays the accumulated CAN frames.

More specifically, the relay unit 11 accumulates CAN frames received from the communication unit 13 in the storage unit 14, for example, in order of reception, that is, in the order in which the CAN frames are received from the communication unit 13. The relay unit 11 retrieves the CAN frames from the storage unit 14 and transmits the CAN frames to the in-vehicle ECUs 111 via the communication unit 13, the communication port 10, and the bus 1, according to an instruction from the monitoring unit 12.

The monitoring unit 12 performs acquisition processing for acquiring the measurement result of the communication load on the bus 1 to which the CAN frames are to be relayed. For example, the monitoring unit 12 acquires the measurement result of the communication load for each bus 1.

Specifically, for example, the monitoring unit 12 calculates the communication load on the bus 1 to which the CAN frames are to be relayed, based on the CAN frames accumulated by the relay unit 11.

More specifically, the monitoring unit 12 monitors the CAN frames accumulated in the storage unit 14 (hereinafter also referred to as accumulated frames), and calculates the communication load on the bus 1 to which the accumulated frames are to be transferred (hereinafter also referred to as bus load) based on the accumulated frames. For example, the monitoring unit 12 calculates, for each bus 1, the number of CAN frames accumulated per unit time or the data amount in the DAT field of the CAN frames as the bus load.

The monitoring unit 12 determines, based on the acquired measurement result of the bus load, whether the load state of the bus 1 to which the CAN frames are to be transferred is a normal state or a high load state. Specifically, for example, the monitoring unit 12 determines that the load state is a normal state if the above-mentioned number or data amount is less than a predetermined threshold, and determines that the load state is a high load state if the number or data amount is greater than or equal to the threshold. The monitoring unit 12 outputs load information indicating the determination result for each bus 1 to the relay unit 11 as the instruction. The monitoring unit 12 performs this acquisition processing periodically or non-periodically.

FIG. 4 is a diagram showing an example of a priority level table in the in-vehicle relay device according to the embodiment of the present disclosure.

With reference to FIG. 4, the storage unit 14 stores a priority level table TP indicating the correspondence between CAN-IDs and priority levels.

Specifically, in the in-vehicle communication system 301, three priority levels: high, medium, and low, are set for CAN frames, for example. The priority levels of CAN frames with CAN-IDs 0x100, 0x200, 0x300, 0x400, 0x500, and 0x600 are medium, high, low, low, medium, and high, respectively. Here, “Ox” means that the number that follows is in hexadecimal.

For example, CAN frames include periodic frames that contain periodically transmitted messages and event frames that contain event messages.

As one example, a CAN frame with a “high” priority level is a frame that contains a control message for autonomous driving of the vehicle in which the in-vehicle communication system 301 is installed, a CAN frame with a “medium” priority level is a frame that contains an event message generated in response to an event such as door opening/closing, and a CAN frame with a “low” priority level is a frame that contains a periodic message generated periodically, such as sensor measurement results.

The number of priority levels set in the in-vehicle communication system 301 is not limited to three, and may be two or four or more. The number of priority levels is preset based on the types of CAN frames to be relayed in the in-vehicle communication system 301, the specifications of the in-vehicle relay device 101, and the like.

The monitoring unit 12 classifies CAN frames received by the in-vehicle relay device 101 into groups corresponding to the respective priority levels.

Specifically, with reference to FIGS. 3 and 4, the storage unit 14 has a queue region for each bus 1 and for each priority level.

The monitoring unit 12 distributes the accumulated frames whose output destination is the bus 1 determined as being in a high load state to queues according to the priority levels corresponding to their CAN-IDs, by referring to the priority level table TP. The monitoring unit 12 may be configured to copy the accumulated frames and store them in queues for all buses 1 before determining the load state.

The relay unit 11 performs selection processing for selecting whether to relay the CAN frames according to the priority levels of the CAN frames or to relay the CAN frames according to the order of reception of the CAN frames at the in-vehicle relay device 101 depending on the measurement result acquired by the monitoring unit 12. For example, for each bus 1, the relay unit 11 performs selection processing for the frames to be relayed to the bus 1 depending on the measurement result corresponding to the bus 1.

More specifically, if the load information received from the monitoring unit 12 indicates a normal state, the relay unit 11 retrieves the CAN frames whose output destination is the corresponding bus 1 from the storage unit 14 in order of accumulation and outputs the CAN frames to the bus 1 via the communication unit 13 and the communication port 10 corresponding to the bus 1.

The foregoing “processing for relaying CAN frames according to the order of reception at the in-vehicle relay device 101” is not limited to the case where the CAN frames are relayed in the exact reception order but also includes the case where the CAN frames are relayed in an order different from the reception order due to, for example, internal processing in the communication unit 13 or the relay unit 11.

If the load information received from the monitoring unit 12 indicates a high load state, the relay unit 11 retrieves the CAN frames whose output destination is the corresponding bus 1 from the queues in descending order of priority level in the storage unit 14 and outputs the CAN frames to the bus 1 via the communication unit 13 and the communication port 10 corresponding to the bus 1.

The monitoring unit 12 may be configured to determine three or more types of load states. In this case, the relay unit 11 performs relay processing according to priority levels if the load state indicated by the load information received from the monitoring unit 12 is a specific load state, and performs relay processing according to reception order if the load state is other than the specific load state. The number of types of specific load states may be one or more.

The monitoring unit 12 may be configured to acquire the bus load measurement result for either one of the buses 1A and 1B. In this case, the relay unit 11 performs selection processing for the bus 1 for which the measurement result has been acquired.

In the storage unit 14, queues corresponding to the respective priority levels may be shared between the buses 1. In this case, the relay unit 11 refers to the routing table to determine the bus 1 that is the output destination based on the CAN-ID of a CAN frame, and retrieves the CAN frame to be relayed from the queue.

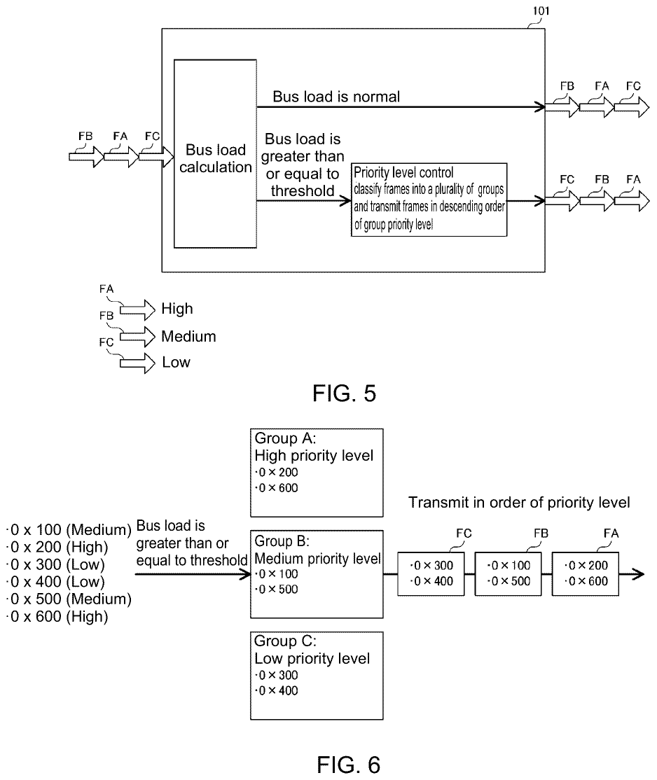

FIGS. 5 and 6 are diagrams for illustrating relay processing and selection processing performed by the in-vehicle relay device according to the embodiment of the present disclosure.

In relay processing for relaying CAN frames according to the priority levels of the CAN frames, the relay unit 11 transmits the CAN frames classified by the monitoring unit 12 on a per-group basis.

Specifically, with reference to FIGS. 5 and 6, in the case where a CAN frame FC with a “low” priority level, a CAN frame FA with a “high” priority level, and a CAN frame FB with a “medium” priority level are received in this order by the in-vehicle relay device 101, if the monitoring unit 12 determines that the load state of the transfer destination bus 1 is a normal state, the CAN frames are output to the transfer destination bus 1 in order of reception: CAN frame FC, CAN frame FA, and CAN frame FB.

If the monitoring unit 12 determines that the load state of the transfer destination bus 1 is a high load state, priority level control is executed, and the CAN frames are output to the transfer destination bus 1 in order of priority level: CAN frame FA, CAN frame FB, and CAN frame FC. That is, the received CAN frames are classified into groups corresponding to the respective priority levels, and are relayed in descending order of group priority level. The order of priority level within each group is determined, for example, in accordance with the CAN specifications.

Specifically, as shown in FIG. 6, CAN frames with CAN-IDs 0x200 and 0x600 grouped into group A with a “high” priority level are relayed first, CAN frames with CAN-IDs 0x100 and 0x500 grouped into group B with a “medium” priority level are relayed next, and CAN frames with CAN-IDs 0x300 and 0x400 grouped into group C with a “low” priority level are relayed next.

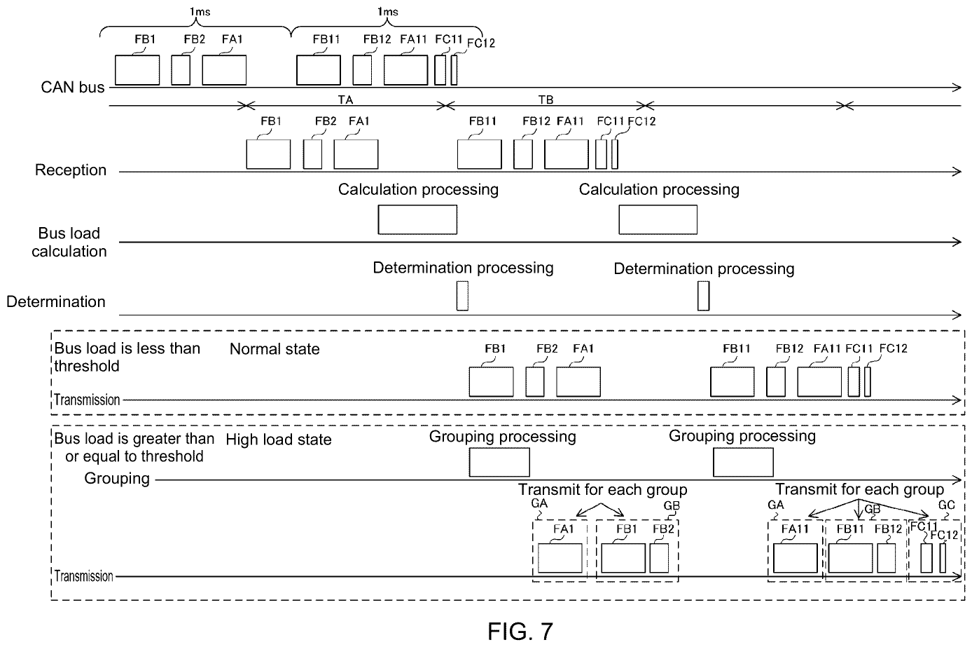

FIG. 7 is a timing chart showing an example of relay processing and selection processing of CAN frames by the in-vehicle relay device according to the embodiment of the present disclosure. As in FIGS. 5 and 6, symbol “FA” indicates a CAN frame with a “high” priority level, “FB” indicates a CAN frame with a “medium” priority level, and “FC” indicates a CAN frame with a “low” priority level.

The relay unit 11 performs selection processing of accumulated frames depending on the communication load calculated based on the accumulated frames.

Specifically, with reference to FIG. 7, it is assumed that CAN frames FB1, FB2, FA1, FB11, FB12, FA11, FC11, and FC12 to be transmitted to in-vehicle ECUs 111 connected to the same bus 1 are output to the bus 1 in this order and received by the in-vehicle relay device 101.

The in-vehicle relay device 101 performs calculation processing for calculating the bus load based on the CAN frames received during a bus load measurement period T, for example, 1 millisecond, and performs determination processing for determining the load state based on the calculated bus load.

Specifically, the in-vehicle relay device 101 calculates the bus load for CAN frames FB1, FB2, and FA1 received during a measurement period TA of 1 millisecond. If the in-vehicle relay device 101 determines that the load state is a normal state, the in-vehicle relay device 101 outputs the CAN frames to the output destination bus 1 in order of reception: CAN frames FB1, FB2, and FA1.

If the in-vehicle relay device 101 determines that the load state is a high load state, the in-vehicle relay device 101 performs grouping processing for the CAN frames and outputs the CAN frames for each group. Specifically, the in-vehicle relay device 101 first outputs CAN frame FA1 belonging to group GA with a “high” priority level, and then outputs CAN frames FB1 and FB2 belonging to group GB with a “medium” priority level.

In parallel with the processing for the measurement period TA, the in-vehicle relay device 101 performs the same processing for the next measurement period TB of 1 millisecond. Specifically, the in-vehicle relay device 101 calculates the bus load for CAN frames FB11, FB12, FA11, FC11, and FC12 received during a measurement period TB. If the in-vehicle relay device 101 determines that the load state is a normal state, the in-vehicle relay device 101 outputs the CAN frames to the output destination bus 1 in order of reception: CAN frames FB11, FB12, FA11, FC11, and FC12.

If the in-vehicle relay device 101 determines that the load state is a high load state, the in-vehicle relay device 101 performs grouping processing for the CAN frames and outputs the CAN frames for each group. Specifically, the in-vehicle relay device 101 first outputs a CAN frame FA11 belonging to a group GA with a “high” priority level, then outputs CAN frames FB11 and FB12 belonging to a group GB with a “medium” priority level, and then outputs CAN frames FC11 and FC12 belonging to a group GC with a “low” priority level.

### Operation Flow

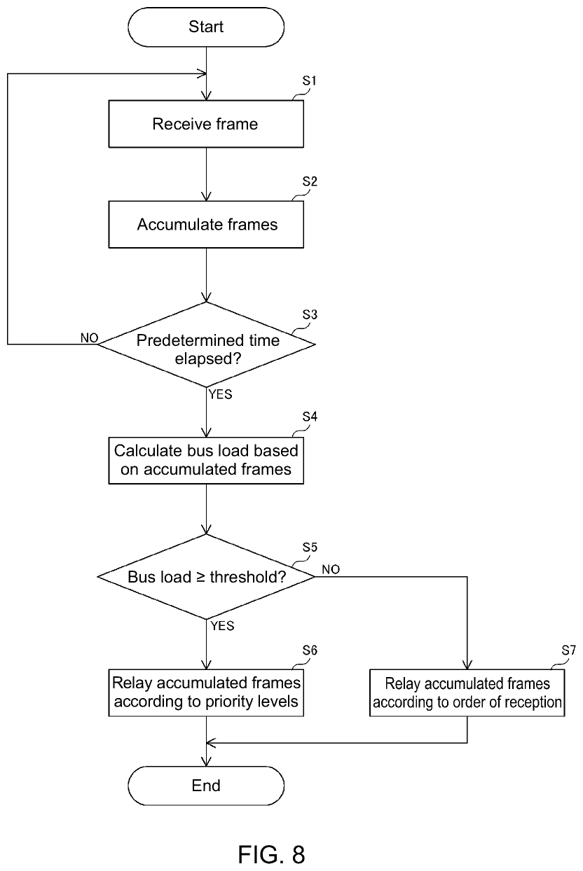

FIG. 8 is a flowchart showing an example of an operation procedure when the in-vehicle relay device according to the embodiment of the present disclosure performs relay processing and selection processing.

With reference to FIG. 8, first, the in-vehicle relay device 101 receives a CAN frame from an in-vehicle ECU 111 (step S1) and accumulates the received CAN frame in the storage unit 14 (step S2). The in-vehicle relay device 101 performs reception and accumulation of CAN frames (steps S1 and S2) until a predetermined time, i.e. the time of the measurement period T, has elapsed (NO in step S3).

When the time of the measurement period T has elapsed (YES in step S3), the in-vehicle relay device 101 calculates the bus load on the bus 1 that is the transfer destination, based on the CAN frames accumulated during the measurement period T (step S4).

If the bus load of the bus 1 is greater than or equal to a threshold (YES in step S5), the in-vehicle relay device 101 relays the accumulated frames whose output destination is the bus 1 according to priority level (step S6).

If the bus load of the bus 1 is less than the threshold (NO in step S5), the in-vehicle relay device 101 relays the accumulated frames whose output destination is the bus 1 in order of reception (step S7).

As described with reference to FIG. 7, the in-vehicle relay device 101 performs the above processing in parallel for temporally consecutive measurement periods T.

In the in-vehicle relay device according to the embodiment of the present disclosure, the relay unit 11 is configured to perform selection processing of accumulated frames depending on the communication load calculated based on the accumulated frames. However, the present disclosure is not limited to this. The relay unit 11 may be configured to perform selection processing of accumulated frames depending on the communication load calculated based on CAN frames received by the in-vehicle relay device 101 before the accumulated frames.

In other words, the relay unit 11 may be configured to perform selection processing of accumulated frames depending on the bus load corresponding to a measurement period T that precedes the measurement period T corresponding to the accumulated frames. For example, the relay unit 11 performs selection processing of accumulated frames depending on the bus load calculated based on CAN frames received during a measurement period T immediately preceding the measurement period T corresponding to the accumulated frames. This configuration can reduce transmission delay of CAN frames accompanying relay processing that includes bus load calculation and the like.

In the in-vehicle relay device according to the embodiment of the present disclosure, the monitoring unit 12 is configured to calculate, based on CAN frames accumulated by the relay unit 11, the communication load on the bus to which the CAN frames are to be relayed. However, the present disclosure is not limited to this. The monitoring unit 12 may be configured to acquire the measurement result of the communication load from outside the in-vehicle relay device 101.

In the in-vehicle communication system 301 according to the embodiment of the present disclosure, the in-vehicle ECUs 111A and 111B are connected to the in-vehicle relay device 101 via the buses 1A and 1B conforming to the CAN standard. However, the present disclosure is not limited to this. The in-vehicle ECUs 111A and 111B may be connected to the in-vehicle relay device 101 via buses conforming to a standard other than CAN, such as CAN FD, Local Interconnect Network (LIN), or Clock Extension Peripheral Interface (CXPI).

The in-vehicle communication system 301 according to the embodiment of the present disclosure may include in-vehicle ECUs 111 connected to the in-vehicle relay device 101 via buses conforming to different standards.

The above embodiment is to be considered illustrative and not restrictive in all respects. The scope of the present disclosure is defined by the claims, and not the above description, and is intended to include all modifications within the meaning and scope equivalent to the claims.

The above description includes the following additional features.

### Supplementary Note 1

An in-vehicle relay device configured to perform relay processing of frames transmitted and received between functional units in an in-vehicle network, the in-vehicle relay device including a processing circuit, wherein the processing circuit is configured to: perform relay processing for relaying frames transmitted and received between in-vehicle devices; acquire a measurement result of a communication load on a bus to which the frames are to be relayed; and perform selection processing for selecting whether to relay the frames according to priority levels of the frames or to relay the frames according to order of reception of the frames at the in-vehicle relay device, depending on the measurement result acquired.

1. An in-vehicle relay device comprising:
a relay unit configured to perform relay processing for relaying frames transmitted and received between in-vehicle devices; and
a monitoring unit configured to acquire a measurement result of a communication load on a bus to which the frames are to be relayed,
wherein the relay unit performs selection processing for selecting whether to relay the frames according to priority levels of the frames or to relay the frames according to order of reception of the frames at the in-vehicle relay device, depending on the measurement result acquired by the monitoring unit.

2. The in-vehicle relay device according to claim 1,
wherein the relay unit accumulates the frames received by the in-vehicle relay device and relays the frames that were accumulated, and
the monitoring unit calculates the communication load on the bus to which the frames are to be relayed, based on the frames accumulated by the relay unit.

3. The in-vehicle relay device according to claim 2, wherein the relay unit performs the selection processing for accumulated frames that are the frames that were accumulated, depending on the communication load calculated based on the accumulated frames.

4. The in-vehicle relay device according to claim 1,
wherein the monitoring unit acquires a measurement result of a communication load on each bus, and
the relay unit performs, for each bus, the selection processing for frames to be relayed to the bus depending on the measurement result corresponding to the bus.

5. The in-vehicle relay device according to claim 1,
wherein the relay unit performs the relay processing for relaying a periodic frame containing a periodically transmitted message and an event frame containing an event message, and
the event frame is assigned a higher priority level than the periodic frame.

6. The in-vehicle relay device according to claim 1,
wherein the monitoring unit classifies the frames received by the in-vehicle relay device into groups corresponding to the respective priority levels, and
the relay unit transmits, on a per-group basis, the frames classified by the monitoring unit, in the relay processing for relaying the frames according to the priority levels of the frames.

7. A relay method in an in-vehicle relay device that relays frames transmitted and received between in-vehicle devices, the relay method comprising:
a step of acquiring a measurement result of a communication load on a bus to which the frames are to be relayed; and
a step of performing selection processing for selecting whether to relay the frames according to priority levels of the frames or to relay the frames according to order of reception of the frames at the in-vehicle relay device, depending on the acquired measurement result.

8. A relay program to be used in an in-vehicle relay device, the relay program causing a computer to function as:
a relay unit configured to perform relay processing for relaying frames transmitted and received between in-vehicle devices; and
a monitoring unit configured to acquire a measurement result of a communication load on a bus to which the frames are to be relayed,
wherein the relay unit performs selection processing for selecting whether to relay the frames according to priority levels of the frames or to relay the frames according to order of reception of the frames at the in-vehicle relay device, depending on the measurement result acquired by the monitoring unit.
